(19) United States
(12) Patent Application Publication
(10) Pub. No.: US 2015/0142558 A1
(43) Pub. Date: May 21, 2015

(54) CONTENT DISTRIBUTION SYSTEM

(71) Applicant: NIKON CORPORATION, Tokyo (JP)

(72) Inventors: Kaori SUZUKI, Kawasaki (JP); Takeshi YAGI, Tokyo (JP); Hiroshige OKAMURA, Yokohama (JP)

(73) Assignee: NIKON CORPORATION, Tokyo (JP)

(21) Appl. No.: 14/608,733

(22) Filed: Jan. 29, 2015

Related U.S. Application Data
(63) Continuation of application No. PCT/JP2013/071047, filed on Aug. 2, 2013.

(30) Foreign Application Priority Data
Aug. 3, 2012 (JP) 2012-173187

(51) Int. Cl. G06Q 30/02

(52) U.S. Cl. CPC G06Q 30/0246; G06Q 30/0267
USPC 705/14.45

(57) ABSTRACT

A content distribution system includes a content storage part that stores at least information, which corresponds to a subarea inside a specific area as content, a sales volume information-acquiring part that acquire sales volume information, a sales volume information storage part that stores the sales volume information, a distribution request-receiving part that receives a distribution request for a content, a distribution permission-determining part that determines whether a distribution of a content is permitted, a content-selecting part that selects the content to be distributed to the mobile electronic device, a content-distributing part that distributes the selected content, a distribution performance storage part, and a contribution point-calculating part that calculates a contribution point of the content distribution service.

### CROSS-REFERENCE TO RELATED APPLICATION

Priority is claimed on Japanese Patent Application No. 2012-173187, filed on Aug. 3, 2012. This application is a continuation application of International Patent Application No. PCT/JP2013/071047, filed on Aug. 2, 2013. The contents of these applications are incorporated herein by reference.

### BACKGROUND

### Technical Field

The present invention relates to a content distribution system. In the related art, a content providing system is known which provides contents to portable terminals (for example, see Japanese Unexamined Patent Application, First Publication No. 2011-191871). In the technique described in Japanese Unexamined Patent Application, First Publication No. 2011-191871, contents are downloaded to portable terminals on the basis of position information of the portable terminals. Additionally, Japanese Unexamined Patent Application, First Publication No. 2011-191871 also describes that the content providing system can be utilized in the field of entertainment.

### SUMMARY

However, when the content providing system according to the related art is introduced into a specific area (such as a zoo or a baseball park), it is difficult to objectively understand economic effects that the specific area (the specific area side or the system introducer side) can acquire by the introduction of the system. Accordingly, there is a problem in that it is difficult to evaluate the content providing system (for example, calculate a degree of contribution of the system introduction to the specific area, such as an improvement in customer attraction and an increase in sales volume) after the content providing system has been introduced. Additionally, Visual or auditory contents may be low in freshness and lack of entertainment value.

An aspect of the present invention provides a contents distribution technique which is high in entertainment value and which is easy to evaluate after a content providing system has been introduced.

According to an aspect of the present invention, a content distribution system is provided that provides a content distribution service of distributing content to mobile electronic device present in a specific area, the content distribution system including: a content storage part configured to store at least information, which corresponds to a subarea set in advance inside the specific area, as the content; a sales volume information-acquiring part configured to acquire sales volume information including an admission fee to the specific area; a sales volume information storage part configured to store the sales volume information; a distribution request-receiving part configured to receive a distribution request for a content from the mobile electronic device; a distribution permission-determining part configured to determine whether a distribution of a content to the mobile electronic device having transmitted the distribution request is permitted; a content-selecting part configured to select the content to be distributed to the mobile electronic device, to which the distribution of the content is permitted by the distribution permission-determining part, from the content storage part; a content-distributing part configured to distribute the content selected by the content-selecting part; a distribution performance storage part configured to store distribution performance information indicating distribution performance by the content-distributing part; and a contribution point-calculating part configured to calculate a contribution point of the content distribution service on the basis of the sales volume information in the sales volume information storage part and the distribution performance information in the distribution performance storage part.

According to another aspect of the present invention, a content distribution system is provided that provides a content distribution service of distributing content to mobile electronic device present in a specific area, the content distribution system including: a content storage part configured to store at least information, which corresponds to event occurring inside the specific area, as the content; a sales volume information-acquiring part configured to acquire sales volume information including an admission fee to the specific area; a sales volume information storage part configured to store the sales volume information; a distribution request-receiving part configured to receive a distribution request for a content from the mobile electronic device; a distribution permission-determining part configured to determine whether a distribution of a content to the mobile electronic device having transmitted the distribution request is permitted; a content-selecting part configured to select the content to be distributed to the mobile electronic device, to which the distribution of the content is permitted by the distribution permission-determining part, from the content storage part; a content-distributing part configured to distribute the content selected by the content-selecting part; a distribution performance storage part configured to store distribution performance information indicating distribution performance by the content-distributing part; and a contribution point-calculating part configured to calculate a contribution point of the content distribution service on the basis of the sales volume information in the sales volume information storage part and the distribution performance information in the distribution performance storage part.

According to the aspects of the present invention, it is possible to provide a content distribution technique which is high in entertainment value and which is easy to evaluate after a content providing system has been introduced.

### BRIEF DESCRIPTION OF THE DRAWINGS

FIG. 1 is a functional block diagram illustrating an example of a content distribution system according to a first embodiment.

FIG. 2 is a diagram illustrating an example of information stored in a content storage part according to the first embodiment.

FIG. 3A is a flowchart illustrating an example of an operation flow of the content distribution system according to the first embodiment.

FIG. 3B is a flowchart illustrating another example of the operation flow of the content distribution system according to the first embodiment.

FIG. 3C is a flowchart illustrating still another example of the operation flow of the content distribution system according to the first embodiment.

FIG. 4 is a functional block diagram illustrating an example of a content distribution system according to a second embodiment.

FIG. 5 is a diagram illustrating an example of information stored in a content storage part according to the second embodiment.

FIG. 6A is a flowchart illustrating an example of an operation flow of the content distribution system according to the second embodiment.

FIG. 6B is a flowchart illustrating another example of the operation flow of the content distribution system according to the second embodiment.

FIG. 6C is a flowchart illustrating still another example of the operation flow of the content distribution system according to the second embodiment.

FIG. 7 is a functional block diagram illustrating an example of a content distribution system according to a third embodiment.

FIG. 8 is a diagram illustrating an example of information stored in a content storage part.

FIG. 9 is a functional block diagram illustrating an example of a content distribution system according to a fourth embodiment.

FIG. 10 is a diagram illustrating an example of information stored in a content storage part.

### DESCRIPTION OF THE EMBODIMENTS

### First Embodiment

A content distribution system 1 according to a first embodiment of the present invention provides a content distribution service of distributing contents to mobile electronic devices (hereinafter, referred to as electronic device T1) present in a specific area. Plural subareas are set in advance in the specific area (hereinafter, referred to as specific area A1) to which the content distribution system 1 is applied. Here, it is not necessary to set the subareas such that all positions in the specific area A1 belong to any subarea. That is, a position not belonging to any sub area may be present in the specific area A1. The specific area A1 only has to be a space suitable for aspects in which contents different depending on the subareas are distributed regardless of whether the specific area is indoors or outdoors. Examples of the specific area A1 include a zoo and a museum (for example, railway museum).

The electronic device T1 includes at least an operation part that is operated by a user, a communication part that communicates with the content distribution system 1, and a vibration part (for example, a vibration motor, a linear vibrator, or a voice coil motor) that causes the housing of a device body (host device) to vibrate. The electronic device T1 may include a position-detecting part (for example, GPS) that detects the position of the housing of the device body. The electronic device T1 transmits a distribution request for contents to the content distribution system 1 and receives contents from the content distribution system 1. The electronic device T1 may be owned by a user or may be rented from the specific area A1.

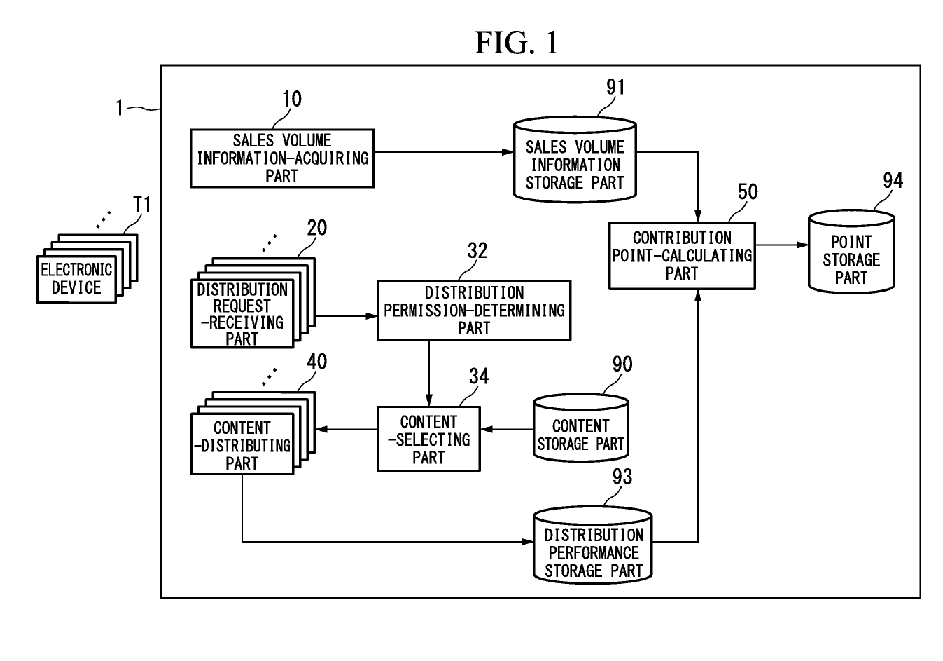

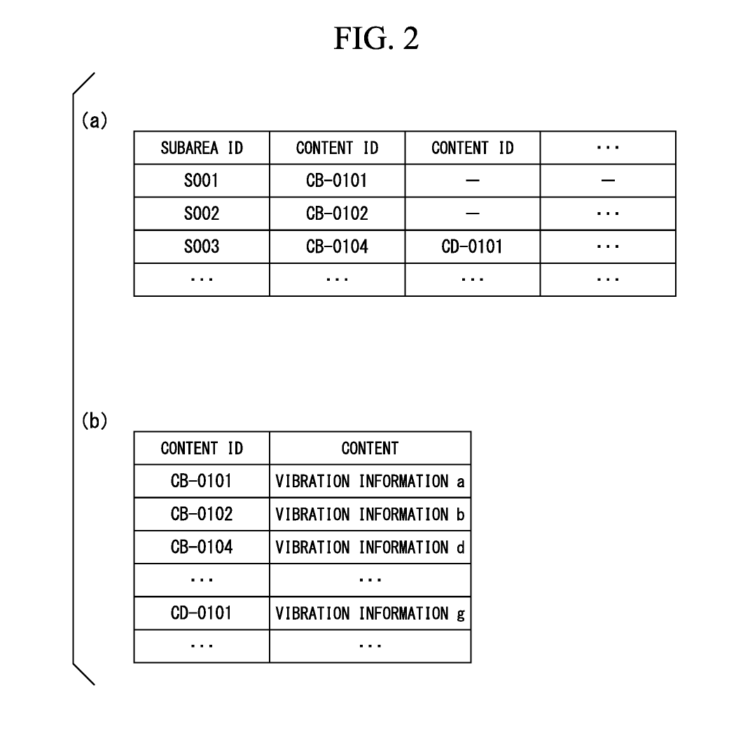

FIG. 1 is a functional block diagram illustrating an example of the content distribution system 1. FIG. 2 is a diagram illustrating an example of information stored in a content storage part 90.

As illustrated in FIG. 1, the content distribution system 1 includes a sales volume information-acquiring part 10, a distribution request-receiving part 20, a distribution permission-determining part 32, a content-selecting part 34, a content-distributing part 40, a contribution point-calculating part 50, a content storage part 90, a sales volume information storage part 91, a distribution performance storage part 93, and a point storage part 94. The content distribution system 1 (content distribution systems 2 to 4 to be described later) includes one or two or more electronic devices (for example, a server, a personal computer, a database, and various communication devices).

The content storage part 90 stores contents to be distributed from the content distribution system 1. The contents stored in the content storage part 90 include vibration information (such as a vibration file, vibration data, and vibration parameters) for causing the housing of the electronic device T1 having received the contents to vibrate. That is, when the electronic device T1 receives vibration information via the communication part, the housing thereof is made to vibrate on the basis of the vibration information by the vibration part.

The content storage part 90 may store moving image information (such as a moving image file, moving image data, and moving image parameters), still image information (a still image file, still image data, and still image parameters), and sound information (a sound file, sound data, and sound parameters) as contents in addition to the vibration information.

Specifically, the content storage part 90 stores contents (which includes at least vibration information) corresponding to the subareas in the specific area A1. For example, the content storage part 90 stores content IDs for identifying contents in correlation with subarea IDs for identifying the subareas, as illustrated in FIG. 2(a). The content storage part 90 stores contents in correlation with the content IDs as illustrated in FIG. 2(b). In the example illustrated in FIG. 2, the content storage part 90 stores vibration information a as contents corresponding to the subarea with a subarea ID of “S001”, vibration information b as contents corresponding to the subarea with a subarea ID of “S002”, and vibration information d and moving image information g as contents corresponding to the subarea with a subarea ID of “S003”.

The sales volume information-acquiring part 10 acquires sales volume information including an admission fee to the specific area A1. For example, sales volume information-acquiring part 10 acquires sales volume information including an admission fee input by an operator's operation (for example, key input) assigned to a gate of the specific area A1 or an admission fee caused by a visitor's operation (for example, an operation of making the electronic device T1 close for the purpose of near-field communication) at the gate. An electronic device (plural electronic devices when plural gates are present in the specific area A1) installed at the gate of the specific area A1 may include the sales volume information-acquiring part 10. The sales volume information storage part 91 stores the sales volume information.

The distribution request-receiving part 20 receives a distribution request for contents from the electronic device T1. The distribution request transmitted from the electronic device T1 includes an electronic device ID for identifying the electronic device T1 and position information of the electronic device T1. The position information of the electronic device T1 is specifically information on the subareas. Accordingly, when transmitting a distribution request at a position belonging to a certain subarea, the electronic device T1 transmits the distribution request including the electronic device ID of the electronic device T1 and the subarea ID to the content distribution system 1. Communication devices (access points) corresponding to the subareas may include the distribution request-receiving part 20. In the following description, the electronic ID may be referred to as device identification information.

The electronic device T1 may acquire the subarea ID of the subarea in which the device body is located from the content distribution system 1 immediately before transmitting the distribution request and may transmit the distribution request including the acquired subarea ID to the content distribution system 1. The electronic device T1 may periodically acquire the subarea ID of the subarea in which the device body is located from the content distribution system 1 and may transmit the distribution request including the finally-acquired subarea ID (newest subarea ID) and the electronic ID to the content distribution system 1.

On the other hand, when transmitting the distribution request at a position not belonging to the subareas, the electronic device T1 transmits the distribution request including the electronic device ID of the electronic device T1 and information (for example, subarea ID=blank) indicating that the device body is located outside the subareas to the content distribution system 1.

At a position not belonging to the subareas, the electronic device T1 may not transmit the distribution request to the content distribution system 1. That is, the electronic device T1 located outside the subareas may not transmit the distribution request to the content distribution system 1.

When the electronic device T1 includes a position-detecting part (for example, GPS), coordinate information detected by the position-detecting part may be used as the information on the subarea instead of the information regarding the subarea. That is, when transmitting the distribution request at a position belonging to the subareas (the same is true when the distribution request can be transmitted at a position not belonging to the subareas), the electronic device T1 may transmit the distribution request including the electronic ID of the electronic device T1 and the coordinate information of the electronic device T1 to the content distribution system 1.

The distribution permission-determining part 32 determines whether distribution of contents to the electronic device T1 having transmitted the distribution request is permitted. Specifically, the distribution permission-determining part 32 permits the distribution of contents when the distribution request is transmitted from the inside of a subarea, and rejects the distribution of contents when the distribution request is transmitted from the outside of the subareas. That is, the distribution permission-determining part 32 permits the distribution of contents when the transmission position of the distribution request is inside any subarea, and rejects the distribution of contents when the transmission position of the distribution request is outside the subareas.

More specifically, in a case in which information on the subareas is used as the position information of the distribution request, the distribution permission-determining part 32 permits the distribution of contents when the distribution request includes the subarea ID of a subarea, and rejects the distribution of contents when the distribution request does not include the subarea ID of any subarea.

In a case in which the coordinate information is used as the position information of the distribution request, the distribution permission-determining part 32 permits the distribution of contents when the distribution request includes the coordinate information corresponding to any subarea with reference to subarea coordinate information (not illustrated) storing the coordinate information of the subareas, and rejects the distribution of contents when the distribution request does not include the coordinate information corresponding to any subarea.

When the electronic device T1 located outside the subareas does not transmits the distribution request to the content distribution system 1, the distribution permission-determining part 32 does not receive the distribution request and thus does not have to permit the distribution of contents.

The content-selecting part 34 selects the content to be distributed to the electronic device T1 to which the distribution is permitted by the distribution permission-determining part 32 from the content storage part 90. Specifically, the content-selecting part 34 selects the content corresponding to the subarea to which the transmission position of the distribution request belongs from the content storage part 90.

The content-distributing part 40 distributes the content selected by the content-selecting part 34. The communication devices corresponding to each of the subareas may include the content-distributing part 40. The distribution performance storage part 93 stores distribution performance information indicating distribution performance of the content-distributing part 40. The distribution performance information may include one or more of the electronic device ID, the content ID, and the subarea ID.

The contribution point-calculating part 50 calculates a contribution point of the content distribution service of the content distribution system 1 on the basis of the sales volume information in the sales volume information storage part 91 and the distribution performance information in the distribution performance storage part 93. In other words, the contribution point-calculating part 50 calculates a degree of contribution of the content distribution service performed by the content distribution system 1 to the specific area A1. The contribution point-calculating part 50 may calculate the contribution point using a calculation formula corresponding to the characteristics of the specific area A1.

For example, the contribution point-calculating part 50 may calculate the contribution point using any one of Calculation Formulas (1) and (2) which are shown below. In Calculation Formulas (1) and (2), P denotes the contribution point, P₁ denotes an admission point (admission fee of a Yen=1 point) into which the admission fee of the sales volume information is converted, and P₂ denotes a distribution point (distribution of one time=b points) into which the number of times of contents distribution in the distribution performance information is converted. Here, a and b are predetermined values (coefficients).

P=P₁+P₂ (1)

P=P₂/P₁ (2)

Calculation Formulas (1) and (2) are only examples and the contribution point-calculating part 50 may calculate the contribution point P using other calculation formulas including the admission point P₁ and the distribution point P₂ as variables.

The point storage part 94 stores the contribution point calculated by the contribution point-calculating part 50. That is, the point storage part 94 stores the degree of contribution of the content distribution service performed by the content distribution system 1 to the specific area A1.

When a fee is set and the content distribution system 1 is introduced into the specific area A1, for example, all or a part of fees of each month may vary depending on the previous contribution point. When the content distribution system 1 is introduced into the specific area A1 by rental, for example, all or a part of rental fees of each month may vary depending on the previous contribution point. The same is true when a content distribution system 2 (to be described later), a content distribution system 3 (to be described later), and a content distribution system 4 (to be described later) are introduced.

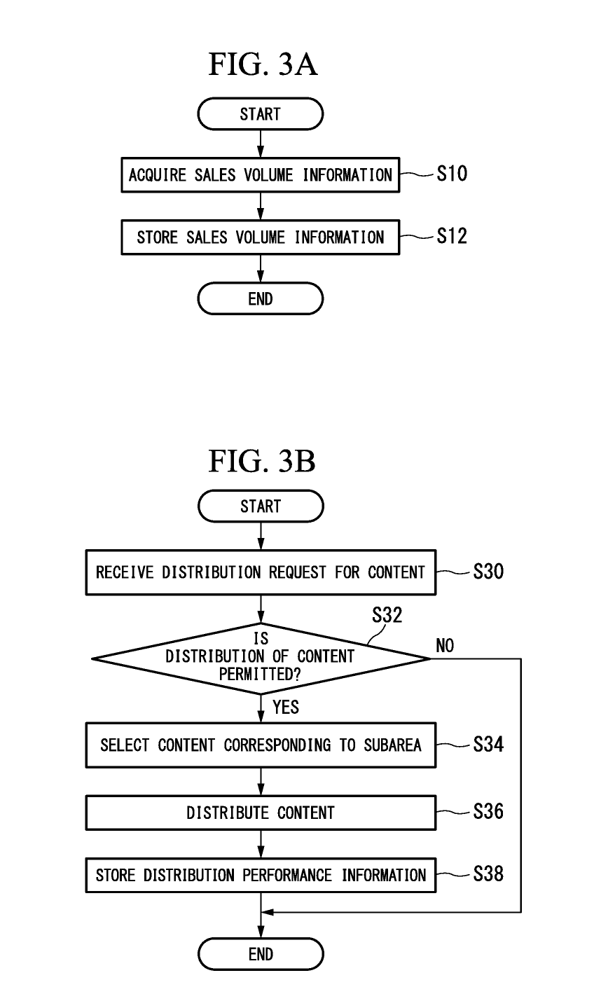

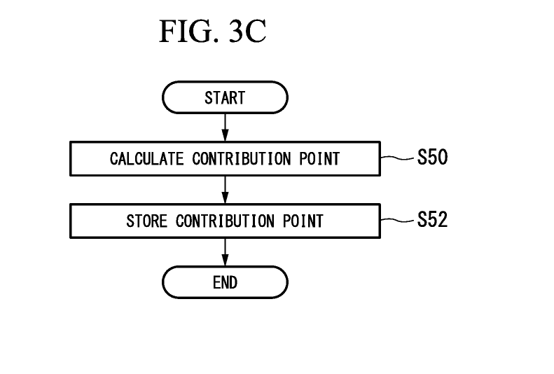

FIGS. 3A, 3B, and 3C are flowcharts illustrating an example of an operation flow of the content distribution system 1. The flowchart of FIG. 3A illustrates the operation flow of entering the specific area A1. The flowchart of FIG. 3A is started in response to an operation of an operator assigned to the gate of the specific area A1 or a visitor's operation at the gate. The flowchart of FIG. 3B illustrates the operation flow of distributing contents. The flowchart of FIG. 3B is started in response to transmission of a distribution request for a content from the electronic device T1. The flowchart of FIG. 3C illustrates the operation flow of calculating the contribution point. The flowchart of FIG. 3C is started at a predetermined date and time (batch process) or is started in response to a predetermined operation of a manager of the content distribution system 1.

In FIG. 3A, the sales volume information-acquiring part 10 acquires the sales volume information including the admission fee to the specific area A1 (step S10). The sales volume information-acquiring part 10 having acquired the sales volume information stores the sales volume information in the sales volume information storage part 91 (step S12). Then, the flowchart of FIG. 3A ends.

As illustrated in the flowchart of FIG. 3A, when a person (a person carrying an own electronic device T1, a person having a rented electronic device T1, or a person not carrying an electronic device T1) enters the specific area A1, sales volume information is accumulated in the sales volume information storage part 91.

In FIG. 3B, the distribution request-receiving part 20 receives a distribution request for contents from the electronic device T1 (step S30). The distribution request-receiving part 20 outputs the distribution request to the distribution permission-determining part 32. The distribution permission-determining part 32 determines whether the distribution of contents to the electronic device T1 is permitted (step S32). Specifically, on the basis of the position information included in the distribution request acquired from the distribution request-receiving part 20, the distribution permission-determining part 32 permits the distribution of contents when the transmission position of the distribution request is inside any subarea, and rejects the distribution of contents when the transmission position of the distribution request is outside the subareas.

When the distribution of contents is permitted in step S32 (YES in step S32), the distribution permission-determining part 32 outputs to the content-selecting part 34 the distribution request (or the electronic device ID included in the distribution request) acquired from the distribution request-receiving part 20 and the subarea ID of the subarea to which the transmission position of the distribution request belongs. The content-selecting part 34 selects from the content storage part 90 a content corresponding to the subarea to which the transmission position of the distribution request belongs (step S34). Specifically, the content-selecting part 34 selects from the content storage part 90 a content corresponding to the subarea ID acquired by the distribution permission-determining part 32. The content-selecting part 34 having selected the content outputs the selected content to the content-distributing part 40 along with the electronic device ID (the electronic device ID included in the distribution request acquired from the distribution permission-determining part 32 or the electronic device ID acquired from the distribution permission-determining part 32) of the electronic device T1. The content-distributing part 40 distributes the content acquired from the content-selecting part 34 to the electronic device T1 with the electronic device ID acquired from the content-selecting part 34 (step S36). The content-distributing part 40 having distributed the content stores the distribution performance information of the content in the distribution performance storage part 93 (step S38). Then, the flowchart of FIG. 3B ends.

The content-distributing part 40 may store the distribution performance information including the electronic device ID acquired from the content-selecting part 34 in the distribution performance storage part 93. The content-distributing part 40 may store the distribution performance information including the content ID in the distribution performance storage part 93. When the distribution performance information including the content ID is stored in the distribution performance storage part 93, the content-selecting part 34 outputs the content ID of the selected content to the content-distributing part 40 in addition to the electronic device ID of the electronic device T1 and the selected content. The content-distributing part 40 may store the distribution performance information including the subarea ID in the distribution performance storage part 93. When the distribution performance information including the subarea ID is stored in the distribution performance storage part 93, the content-selecting part 34 outputs the subarea ID acquired from the distribution permission-determining part 32 to the content-distributing part 40 in addition to the electronic device ID of the electronic device T1 and the selected content. On the other hand, when the distribution of contents is rejected in step S32 (NO in step S32), steps S34, S36, and S38 are skipped and the flowchart of FIG. 3B ends.

As illustrated in the flowchart of FIG. 3B, the distribution performance information is accumulated in the distribution performance storage part 93 when contents are distributed to a person (a person carrying their own electronic device T1 or a person having a rented electronic device T1) in the specific area A1.

In FIG. 3C, the contribution point-calculating part 50 calculates the contribution point of the content distribution service performed by the content distribution system 1 on the basis of the sales volume information in the sales volume information storage part 91 and the distribution performance information in the distribution performance storage part 93 (step S50). The contribution point-calculating part 50 having calculated the contribution point stores the contribution point in the point storage part 94 (step S52). Then, the flowchart of FIG. 3C ends.

As illustrated in the flowcharts of FIGS. 3A, 3B, and 3C, the contribution point of the content distribution service performed by the content distribution system 1 is calculated on the basis of the sales volume information accumulated in the sales volume information storage part 91 when a person enters the specific area A1 and the distribution performance information accumulated in the distribution performance storage part 93 every time the contents are distributed to persons in the specific area A1.

### (Application Example 1 of Content Distribution System 1/Zoo)

The specific area A1 is a zoo. A subarea is set for each viewing area of animals (for example, elephant, lion, . . . ). Vibration information and the like associated with each animal are stored in the content storage part 90 for each subarea (that is, for each animal). For example, in the content storage part 90, vibration information (vibration information of vibration generated when an elephant walks) corresponding to movement of an elephant along with moving image information obtained by recording an image in which the elephant walks is stored and vibration information of vibration generated when a lion pursues a quarry along with sound information including explanations of an image in which a lion hunts is stored in correlation with the subarea of lions.

For example, when a distribution request for contents is received from an electronic device T1 located in a viewing area of elephants (subarea of elephants), the content distribution system 1 distributes contents (the moving image information obtained by recording an image in which the elephant walks and the vibration information of vibration generated when an elephant walks) corresponding to the viewing area of elephants to the electronic device T1. When a distribution request for contents is received from an electronic device T1 located in the viewing area of lions (subarea of lions), the content distribution system 1 distributes contents (the sound information including explanations of an image in which a lion hunts and the vibration information of vibration generated when a lion pursues a quarry) corresponding to the viewing area of lions to the electronic device T1.

That is, a user of an electronic device T1 can obtain vibration information associated with elephants when requesting contents in the vicinity of an elephant, and can obtain vibration information associated with lions when requesting contents in the vicinity of a lion.

The content distribution system 1 stores the sales volume information including an admission fee acquired at the time of admission and the distribution performance information of contents (the total number of times of distribution, the number of times of distribution by animals, the number of times of distribution by electronic devices, and the like) and can calculate the degree of contribution of the content distribution service performed by the content distribution system 1 to the zoo using the stored sales volume information and distribution performance information.

### (Application Example 2 of Content Distribution System 1/Railway Museum)

The specific area A1 is a railway museum. A subarea is set for each viewing area of each vehicle (for example, AA system (00 system), BB system (XX system), . . . ). The content storage part 90 stores vibration information and the like associated with vehicles for each subarea (that is, for each vehicle) as contents associated with a railway. For example, in the content storage part 90, moving image information obtained by recording an image in which the AA system runs and vibration information (vibration information of vibration when the AA system starts, runs, and stops) corresponding to movement of the AA system are stored in correlation with the subarea of the AA system, and vibration information for reproducing vibration in a cabin of the BB system along with sound information including explanations of the history of the BB system is stored in correlation with the subarea of the BB system.

For example, when a distribution request for contents is received from an electronic device T1 located in the viewing area of the AA system (the subarea of the AA system), the content distribution system 1 distributes contents (the moving image information obtained by recording an image in which the AA system runs and the vibration information corresponding to the movement of the AA system) corresponding to the viewing area of the AA system to the electronic device T1. When a distribution request for contents is received from an electronic device T1 located in the viewing area of the BB system (the subarea of the BB system), the content distribution system 1 distributes the contents (the sound information including explanations of the history of the BB system and the vibration information for reproducing vibration in a cabin of the BB system) corresponding to the viewing area of the BB system to the electronic device T1.

That is, a user of the electronic device T1 can obtain the vibration information and the like associated with the AA system when requesting for contents in the vicinity of the AA system and can obtain the vibration information and the like associated with the BB system when requesting for contents in the vicinity of the BB system.

The content distribution system 1 stores the sales volume information including an admission fee acquired at the time of admission and the distribution performance information of contents (the total number of times of distribution, the number of times of distribution by vehicles, the number of times of distribution by electronic devices, and the like) and can calculate the degree of contribution of the content distribution service performed by the content distribution system 1 to the railway museum using the stored sales volume information and distribution performance information.

### Second Embodiment

A content distribution system 2 according to a second embodiment of the present invention provides a content distribution service of distributing contents to mobile electronic devices (hereinafter, referred to as electronic device T2) present in a specific area. The specific area (hereinafter, referred to as specific area A2) to which the content distribution system 2 is applied only has to be a space in which an event occurs regardless of whether the specific area is indoors or outdoors. Examples of the specific area A2 include a sports stadium (for example, a baseball park). Subareas may be set for the specific area A2, similarly to the specific area A1. The electronic device T2 may have the same configuration as the electronic device T1. When the specific area A2 is a baseball park, a home run, a stolen base, and the like correspond to events.

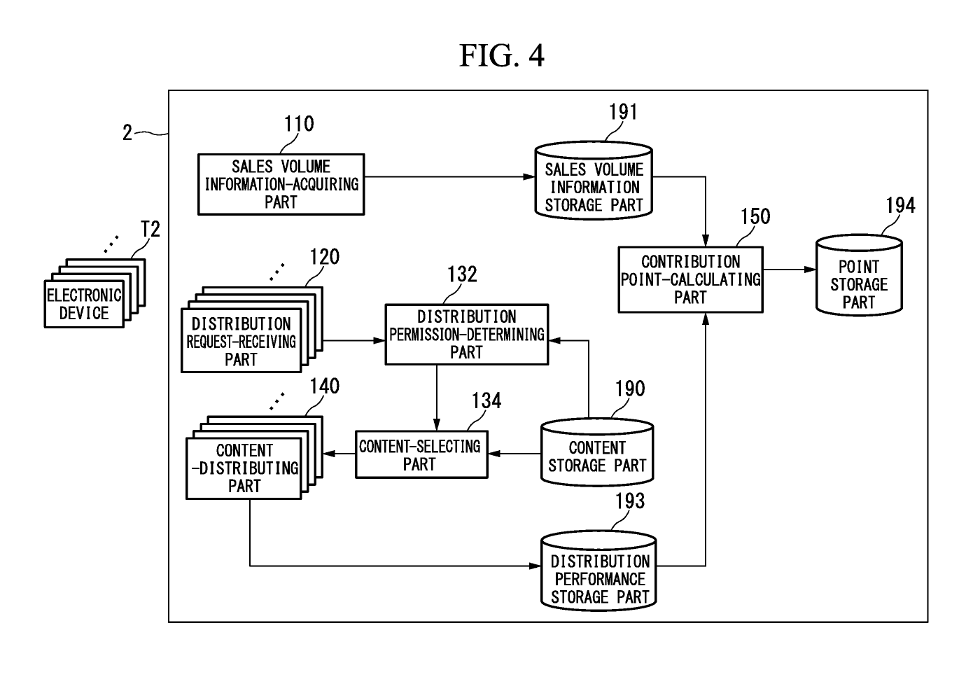

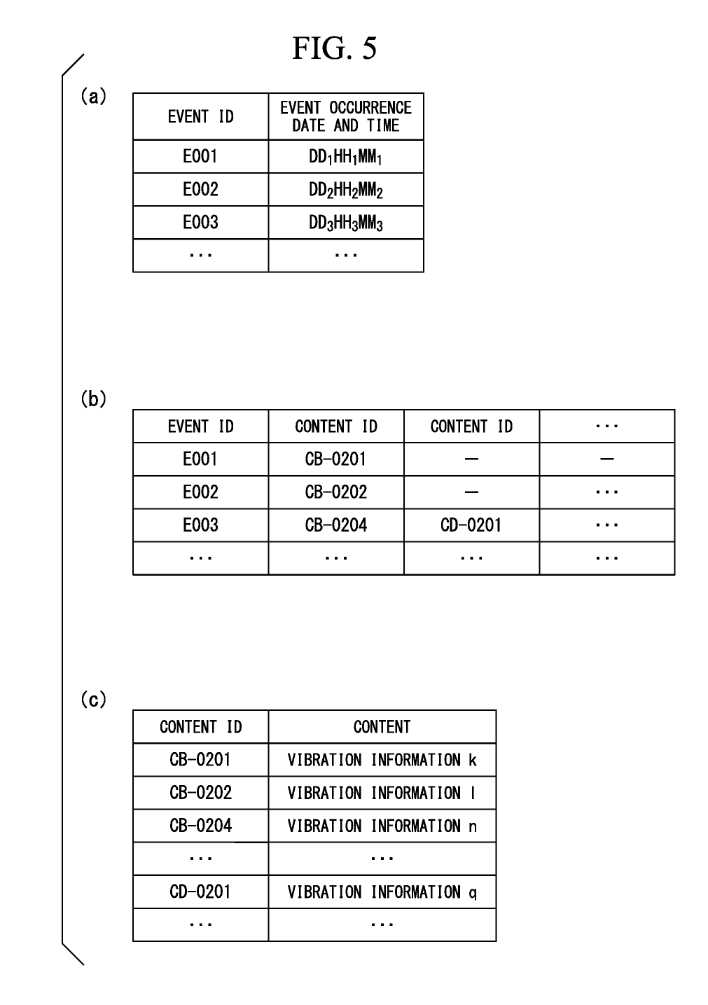

FIG. 4 is a functional block diagram illustrating an example of the content distribution system 2. FIG. 5 is a diagram illustrating an example of information stored in a content storage part 90.

As illustrated in FIG. 4, the content distribution system 2 includes a sales volume information-acquiring part 110, a distribution request-receiving part 120, a distribution permission-determining part 132, a content-selecting part 134, a content-distributing part 140, a contribution point-calculating part 150, a content storage part 190, a sales volume information storage part 191, a distribution performance storage part 193, and a point storage part 194. The sales volume information-acquiring part 110, the sales volume information storage part 191, the distribution performance storage part 193, and the point storage part 194 of the content distribution system 2 are the same as the sales volume information-acquiring part 10, the sales volume information storage part 91, the distribution performance storage part 93, and the point storage part 94 of the content distribution system 1 and thus a part or all of the description thereof will not be repeated.

The content storage part 190 stores contents to be distributed from the content distribution system 2. The contents stored in the content storage part 190 include vibration information for causing the housing of the electronic device T2 having received the contents to vibrate. The content storage part 190 may store moving image information, still image information, and sound information as contents in addition to the vibration information.

Specifically, the content storage part 190 stores contents (which include at least vibration information) corresponding to events in the specific area A2. For example, the content storage part 190 stores occurrence date and times of events in correlation with event IDs for identifying the events, as illustrated in FIG. 5(a). The content storage part 190 stores content IDs in correlation with the event IDs as illustrated in FIG. 5(b). In addition, the content storage part 190 stores the contents in correlation with the content IDs as illustrated in FIG. 5(c). In the example illustrated in FIG. 5, the content storage part 190 stores vibration information k as contents corresponding to the event with an event ID of “E001” occurring at a date and time of “DD₁HH₁MM₁”, vibration information 1 as contents corresponding to the event with an event ID of “E002” occurring at a date and time of “DD₂HH₂MM₂”, and vibration information n and moving image information q as contents corresponding to the event with an event ID of “E003” occurring at a date and time of “DD₃HH₃MM₃”.

After an event actually occurs in the specific area A2, contents associated with the event are stored in the content storage part 190. For example, when the specific area A2 is a baseball park, vibration information (for example, vibration information of vibration generated when a bat and a ball collide with each other) of actual events (for example, a home run) is prepared with reference to the actually-occurring events, and is stored in the content storage part 190 along with numbered event IDs and event occurrence times.

Before an event actually occurs in the specific area A2, contents associated with the event may be stored in the content storage part 190. For example, when the specific area A2 is a baseball park, vibration information of assumed events (for example, a home run with a long flying distance, a home run with a middle flying distance, and a short flying distance regarding home runs) is prepared in advance and is stored as vibration pattern information for each assumed event in the content storage part 190. When an event actually occurs in the specific area A2, vibration pattern information (previously-prepared vibration information) corresponding to the actually-occurring event is selected with reference to the actually-occurring event and is stored in the content storage part 190 along with the numbered event ID and the event occurrence time.

Old contents (contents after a predetermined time passes from the event occurrence time) may be deleted from the content storage part 190.

The distribution request-receiving part 120 receives a distribution request for contents from the electronic device T2. The distribution request transmitted from the electronic device T2 includes an electronic device ID for identifying the electronic device T2. In addition, the distribution request transmitted from the electronic device T2 may include position information (coordinate information or coordinate information or a subarea ID when subareas are set for the specific area A2) of the electronic device T2 in addition to the electronic device ID, similarly to the distribution request transmitted from the electronic device T1. A communication device (communication devices corresponding to subareas when the subareas are set for the specific area A2) installed in the specific area A2 may include the distribution request-receiving part 120. The same is true of a distribution request-receiving part 320 of a content distribution system 4 (to be described later).

The distribution permission-determining part 132 determines whether distribution of contents to the electronic device T2 having transmitted the distribution request is permitted. Specifically, the distribution permission-determining part 132 permits the distribution of contents when the distribution request is transmitted within a predetermined time from the event occurrence time, and rejects the distribution of contents when the distribution request is not transmitted within a predetermined time from the event occurrence time.

More specifically, the distribution permission-determining part 132 permits the distribution of contents when the transmission date and time of the distribution request from the electronic device T2 (or the reception date and time of the distribution request from the distribution request-receiving part 120) is within a predetermined time from the event occurrence date and time of an event stored in the content storage part 190, and rejects the distribution of contents otherwise.

In the example in which contents are prepared after an event occurs, since a preparation time is necessary, there is a possibility that contents associated with the event will not be stored yet in the content storage part 190. Accordingly, the distribution permission-determining part 132 may perform the aforementioned determination when a predetermined time passes after the event occurs.

The content-selecting part 134 selects the contents to be distributed to the electronic device T2 to which the distribution is permitted by the distribution permission-determining part 132 from the content storage part 190. For example, the content-selecting part 134 selects the contents corresponding to the event occurring latest before the transmission time of the distribution request from the content storage part 190. The content-selecting part 134 may select from the content storage part 190 contents (or contents corresponding to the event occurring within a predetermined time and contents which are still not transmitted to the electronic device T2) corresponding to the event occurring within a predetermined time from the transmission date and time of the distribution request from the electronic device T2 (or the reception date and time of the distribution request by the distribution request-receiving part 120).

The content-distributing part 140 distributes the contents selected by the content-selecting part 134. The communication device (communication devices corresponding to each subareas when the subareas are set for the specific area A2) installed in the specific area A2 may include the content-distributing part 140. The same is true of a content-distributing part 340 of a content distribution system 4 (to be described later).

The distribution performance storage part 193 stores distribution performance information indicating distribution performance of the content-distributing part 140. The distribution performance information may include one or more of the electronic device ID, the content ID, and the event ID.

The contribution point-calculating part 150 calculates a contribution point of the content distribution service of the content distribution system 2 on the basis of the sales volume information in the sales volume information storage part 191 and the distribution performance information in the distribution performance storage part 193. In other words, the contribution point-calculating part 150 calculates a degree of contribution of the content distribution service performed by the content distribution system 2 to the specific area A2. The contribution point-calculating part 150 may calculate the contribution point using the same calculation formula as used in the contribution point-calculating part 50 of the content distribution system 1.

As described above, the content distribution system 2 distributes contents corresponding to an event occurring in the specific area A2 to the electronic device T2, but the content distribution system 2 may distribute contents by subareas and events to the electronic device T2 using the same method as in the content distribution system 1 when the subarea areas are set for the specific area A2. When the contents by subareas and events are distributed to the electronic device T2, the contents by subareas and the contents by events are stored in the content storage part 190.

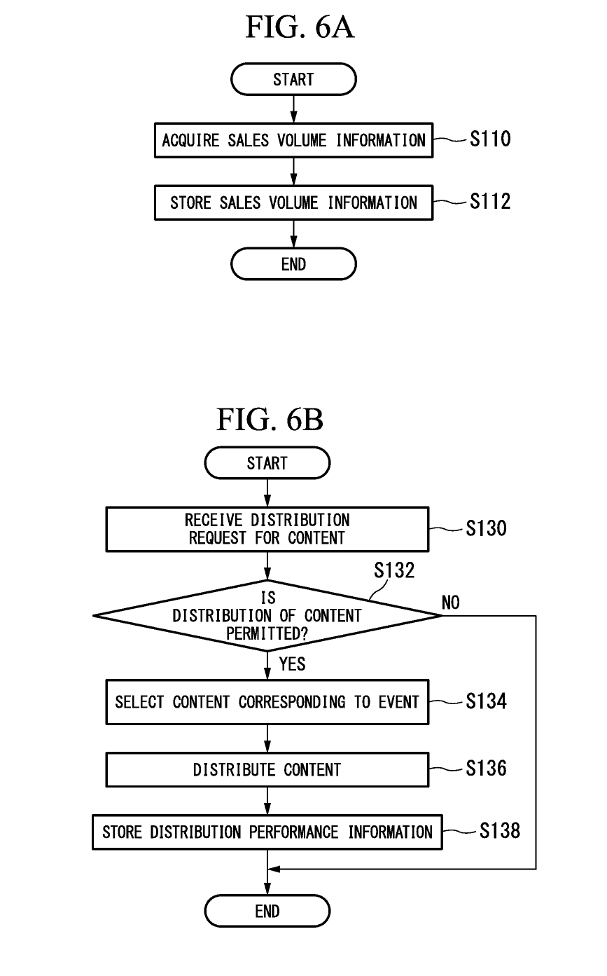

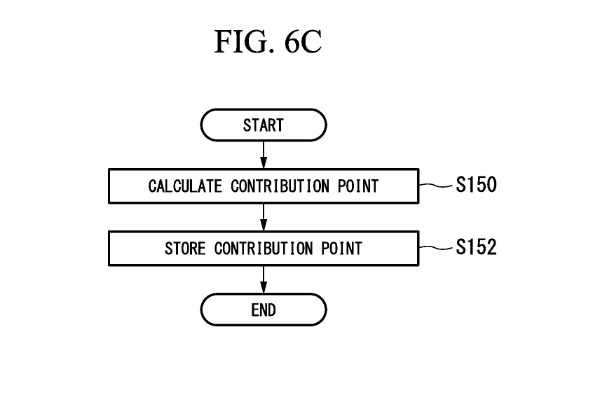

FIGS. 6A, 6B, and 6C are flowcharts illustrating an example of an operation flow of the content distribution system 2. The flowchart of FIG. 6A illustrates the operation flow of entering the specific area A2. The flowchart of FIG. 6A is started in response to an operation of an operator assigned to the gate of the specific area A2 or a visitor's operation at the gate. The flowchart of FIG. 6B illustrates the operation flow of distributing contents. The flowchart of FIG. 6B is started in response to transmission of a distribution request for a content from the electronic device T2. The flowchart of FIG. 6C illustrates the operation flow of calculating the contribution point. The flowchart of FIG. 6C is started at a predetermined date and time (batch process) or is started in response to a predetermined operation of a manager of the content distribution system 2.

In FIG. 6A, similarly to the sales volume information-acquiring part 10 of the content distribution system 1, the sales volume information-acquiring part 110 acquires the sales volume information including the admission fee to the specific area A2 (step S110). The sales volume information-acquiring part 110 having acquired the sales volume information stores the sales volume information in the sales volume information storage part 191 (step S112). Then, the flowchart of FIG. 6A ends.

In FIG. 6B, the distribution request-receiving part 120 receives a distribution request for contents from the electronic device T2 (step S130). The distribution request-receiving part 120 outputs the distribution request to the distribution permission-determining part 132. The distribution permission-determining part 132 determines whether the distribution of contents to the electronic device T2 is permitted (step S132). Specifically, on the basis of the transmission date and time of the distribution request (or the reception date and time of the distribution request), the distribution permission-determining part 132 permits the distribution of contents when the transmission date and time (or the reception date and time) is within a predetermined time from the event occurrence date and time of an event stored in the content storage part 190, and rejects the distribution of contents otherwise.

When the distribution of contents is permitted in step S132 (YES in step S132), the distribution permission-determining part 132 outputs the distribution request (or the electronic device ID included in the distribution request) acquired from the distribution request-receiving part 20 and the transmission date and time (or the reception date and time) of the distribution request to the content-selecting part 134. The content-selecting part 134 selects from the content storage part 190 a content corresponding to the event occurring latest before the transmission date and time (or the reception date and time) of the distribution request (step S134). The content-selecting part 134 having selected the content outputs the selected content to the content-distributing part 140 along with the electronic device ID of the electronic device T2. The content-distributing part 140 distributes the content acquired from the content-selecting part 134 to the electronic device T2 with the electronic device ID acquired from the content-selecting part 134 (step S136). The content-distributing part 140 having distributed the content stores the distribution performance information of the content in the distribution performance storage part 193 (step S138).

Then, the flowchart of FIG. 6B ends.

The content-distributing part 140 may store the distribution performance information including the electronic device ID acquired from the content-selecting part 134 in the distribution performance storage part 193. The content-distributing part 140 may store the distribution performance information including the content ID in the distribution performance storage part 193. When the distribution performance information including the content ID is stored in the distribution performance storage part 193, the content-selecting part 134 outputs the content ID of the selected content to the content-distributing part 140 in addition to the electronic device ID of the electronic device T2 and the selected content. The content-distributing part 140 may store the distribution performance information including the event ID in the distribution performance storage part 193. When the distribution performance information including the event ID is stored in the distribution performance storage part 193, the content-selecting part 134 outputs the event ID occurring latest before the transmission date and time (or the reception date and time) of the distribution request to the content-distributing part 140 in addition to the electronic device ID of the electronic device T2 and the selected content.

On the other hand, when the distribution of contents is rejected in step S132 (NO in step S132), steps S134, S136, and S138 are skipped and the flowchart of FIG. 6B ends.

In FIG. 6C, the contribution point-calculating part 150 calculates the contribution point of the content distribution service performed by the content distribution system 2 on the basis of the sales volume information in the sales volume information storage part 191 and the distribution performance information in the distribution performance storage part 193 (step S150). The contribution point-calculating part 150 having calculated the contribution point stores the contribution point in the point storage part 194 (step S152). Then, the flowchart of FIG. 6C ends.

As illustrated in the flowcharts of FIGS. 6A, 6B, and 6C, the contribution point of the content distribution service of the content distribution system 2 is calculated on the basis of the sales volume information accumulated in the sales volume information storage part 191 when a person enters the specific area A2 and the distribution performance information accumulated in the distribution performance storage part 193 when contents are distributed to persons in the specific area A2.

### (Application Example 1 of Content Distribution System 2/Baseball Park)

The specific area A2 is a baseball park. Vibration information and the like associated with an event are stored in the content storage part 190 after the event occurs. For example, after a home run, the vibration information of the home run (for example, vibration information of vibration when a bat and a ball collide with each other) is immediately prepared with reference to the situation of the home run (for example, features of a batter, the flying distance, and the direction of the batted ball) and is stored in the content storage part 190 along with the event ID and the event occurrence time. After a stolen base, the vibration information of the stolen base (for example, vibration information when base running is started, base running is being performed, and base running is ended) is immediately prepared with reference to the situation of the stolen base (for example, features of a runner, features of sliding, a tagging state and successfulness of the stolen base) and is stored in the content storage part 190 along with the event ID, the event occurrence time, and moving image information obtained by recording the scene of the stolen base.

For example, when a distribution request for contents is received from an electronic device T2 immediately after a home run, the content distribution system 2 distributes the vibration information of the home run to the electronic device T2. When a distribution request for contents is received from an electronic device T2 immediately after a stolen base, the content distribution system 2 distributes the vibration information of the stolen base and the moving image information obtained by recording the scene of the stolen base to the electronic device T2.

That is, a user of an electronic device T2 can obtain vibration information and the like associated with the home run when requesting contents immediately after the home run, and can obtain vibration information and the like associated with the stolen base when requesting contents immediately after the stolen base.

The content distribution system 2 stores the sales volume information including an admission fee acquired at the time of admission and the distribution performance information of contents (the total number of times of distribution, the number of times of distribution by events, the number of times of distribution by electronic devices, and the like) and can calculate the degree of contribution of the content distribution service performed by the content distribution system 2 to the baseball park (or the baseball club) using the stored sales volume information and distribution performance information.

### Third Embodiment

A content distribution system 3 according to a third embodiment of the present invention is applied to a specific area A1 (such as a zoo and a railway museum) and provides a content distribution service of distributing contents to electronic devices T1 which are present in the specific area A1, similarly to the content distribution system 1. The content distribution service provided by the content distribution system 3 distributes contents for free (hereinafter, referred to as free contents) or paid contents (hereinafter, referred to as non-free contents).

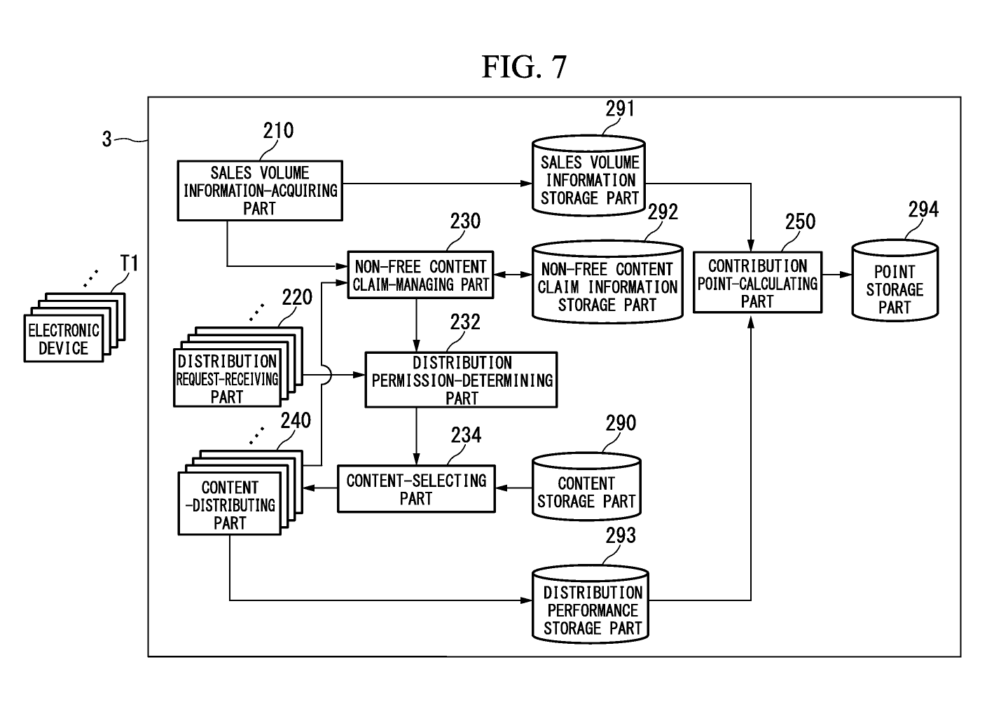

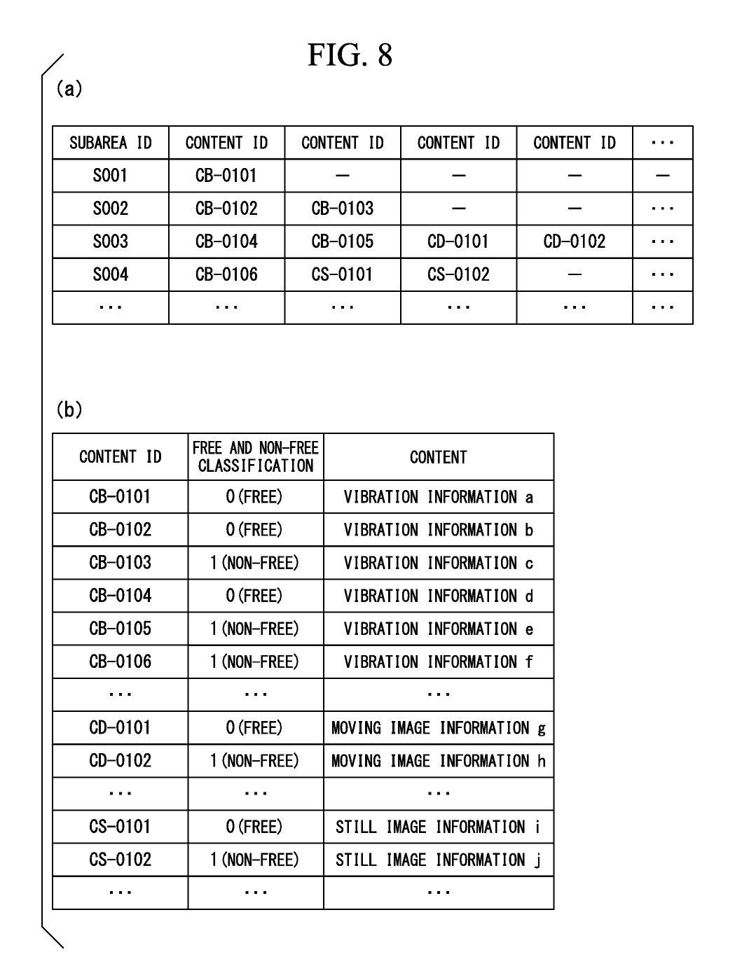

FIG. 7 is a functional block diagram illustrating an example of the content distribution system 3. FIG. 8 is a diagram illustrating an example of information stored in a content storage part 290.

As illustrated in FIG. 7, the content distribution system 3 includes a sales volume information-acquiring part 210, a distribution request-receiving part 220, a non-free content claim-managing part 230, a distribution permission-determining part 232, a content-selecting part 234, a content-distributing part 240, a contribution point-calculating part 250, a content storage part 290, a sales volume information storage part 291, a non-free content claim information storage part 292, a distribution performance storage part 293, and a point storage part 294.

The content storage part 290 stores contents to be distributed from the content distribution system 3. The contents stored in the content storage part 290 include vibration information (free contents and/or non-free contents) for causing the housing of the electronic device T1 having received the contents to vibrate. The content storage part 290 may store moving image information (free contents and/or non-free contents), still image information (free contents and/or non-free contents), and sound information (free contents and/or non-free contents) as contents in addition to the vibration information.

Specifically, the content storage part 290 stores contents (which includes at least vibration information) corresponding to the subareas in the specific area A1 so as to distinguish free contents and non-free contents. For example, the content storage part 290 stores content IDs in correlation with subarea IDs, as illustrated in FIG. 8(a). The content storage part 290 stores free and non-free classification of distinguishing free and non-free contents from each other and contents in correlation with the content IDs as illustrated in FIG. 8(b). In the example illustrated in FIG. 8, the content storage part 290 stores vibration information a which is free contents as contents corresponding to the subarea with a subarea ID of “S001”, vibration information b which is free contents and vibration information c which is non-free contents as contents corresponding to the subarea with a subarea ID of “S002”, and vibration information d and moving image information g which are free contents and vibration information e and moving image information h which are non-free contents, as contents corresponding to the subarea with a subarea ID of “S003”.

The sales volume information-acquiring part 210 acquires sales volume information (sales volume information further including a purchase fee of non-free contents as for a purchaser of the non-free contents) including an admission fee to the specific area A1. The purchaser of the non-free contents is a person wanting to distribute the non-free contents. The acquisition of the sales volume information by the sales volume information-acquiring part 210 is similar to the acquisition of the sales volume information by the sales volume information-acquiring part 10 of the content distribution system 1. An electronic device (plural electronic devices when plural gates are present in the specific area A1) installed at the gate of the specific area A1 may include the sales volume information-acquiring part 210.

The sales volume information-acquiring part 210 stores the sales volume information in the sales volume information storage part 291. The sales volume information-acquiring part 210 outputs the purchase fee of the non-free contents and the electronic device ID of the electronic device T1 to the non-free content claim-managing part 230.

The non-free content claim information storage part 292 stores information (hereinafter, referred to as non-free content claim information) indicating a claim for the non-free contents in correlation with the electronic device ID of the electronic device T1. The non-free content claim information is, for example, a purchase fee of non-free contents or a value (for example, the allowable number of times of distribution of non-free contents) corresponding to the purchase fee of the non-free contents.

The non-free content claim-managing part 230 manages the non-free content claim information. Specifically, the non-free content claim-managing part 230 accumulates the non-free content claim corresponding to the electronic device ID of the electronic device T1 of the user in response to the acquisition of the purchase fee of the non-free contents from a user and consumes the non-free content claim corresponding to the electronic device ID of an electronic device T1 in response to the distribution of the non-free contents to an electronic device T1.

More specifically, the non-free content claim-managing part 230 increases the non-free content claim information in the non-free content claim information storage part 292 when the purchase information of non-free contents is acquired from the sales volume information-acquiring part 210. The non-free content claim-managing part 230 decreases the non-free content claim information in the non-free content claim information storage part 292 when the distribution performance information of non-free contents is acquired from the content-distributing part 240.

The distribution request-receiving part 220 receives a distribution request for contents from the electronic device T1. The distribution request transmitted from the electronic device T1 includes an electronic device ID for identifying the electronic device T1, position information of the electronic device T1, and information designating non-free contents. In other words, the distribution request-receiving part 220 receives from the electronic device T1 one of the distribution request among of a distribution request designating non-free contents and including the electronic device ID and the position information, or a distribution request not designating non-free contents (or a distribution request designating free contents as the distribution request including the electronic device ID and the position information) and including the electronic device ID and the position information. Communication devices (access points) corresponding to the subareas may include the distribution request-receiving part 220.

The distribution permission-determining part 232 determines whether the distribution of contents to the electronic device T1 having transmitted the distribution request is permitted. Specifically, the distribution permission-determining part 232 permits the distribution of free contents when the distribution request is transmitted from the inside of a subarea in response to the distribution request not designating non-free contents (or a distribution request designating free contents as the distribution request including the electronic device ID and the position information) and including the electronic device ID and the position information, and rejects the distribution of free contents otherwise. That is, the distribution permission-determining part 232 permits the distribution of free contents when the transmission position of the distribution request is inside any subarea, and rejects the distribution of free contents when the transmission position of the distribution request is outside the subareas.

The distribution permission-determining part 232 permits the distribution of non-free contents when the distribution request is transmitted from the inside of a subarea in response to the distribution request designating non-free contents and including the electronic device ID and the position information, and when the non-free content claim information required for the distribution of non-free contents is stored in the non-free content claim-managing part 230 in correlation with the electronic device ID of the mobile electronic device T, and rejects the distribution of non-free contents otherwise. That is, the distribution permission-determining part 232 permits the distribution of non-free contents when the transmission position of the distribution request is inside any subarea and the purchase fee of the non-free contents is collected, and rejects the distribution of non-free contents when the transmission position of the distribution request is outside the subareas or the purchase fee is not collected.

The content-selecting part 234 selects from the content storage part 290 the contents to be distributed to the electronic device T1 to which the distribution is permitted by the distribution permission-determining part 232. Specifically, the content-selecting part 234 selects from the content storage part 290 free contents corresponding to the subarea to which the transmission position of the distribution request belongs in response to a distribution request not designating non-free contents (or a distribution request designating free contents as the distribution request including the electronic device ID and the position information) including the electronic device ID and the position information. For example, when the information illustrated in FIG. 8 is stored in the content storage part 290 and the subarea to which the transmission position of the distribution request belongs is the subarea with a subarea ID of “S003”, the content-selecting part 234 selects the vibration information d and the moving image information g which are free contents.

The content-selecting part 234 selects from the content storage part 290 the non-free contents corresponding to the subarea to which the transmission position of the distribution request belongs in response to a distribution request designating non-free contents and including the electronic device ID and the position information. For example, when the information illustrated in FIG. 8 is stored in the content storage part 290 and the subarea to which the transmission position of the distribution request belongs is the subarea with a subarea ID of “S003”, the content-selecting part 234 selects the vibration information e and the moving image information h which are non-free contents.

The content-distributing part 240 distributes the content selected by the content-selecting part 234. The communication devices corresponding to the subareas may include the content-distributing part 240. The distribution performance storage part 293 stores distribution performance information (which includes free and non-free classification) indicating distribution performance of the content-distributing part 240. The distribution performance information stored in the distribution performance storage part 293 may include one or more of the electronic device ID, the content ID, and the subarea ID, similarly to the distribution performance information stored in the distribution performance storage part 93.

The content-selecting part 234 outputs the free and non-free classification of the selected content along with the content selected from the content storage part 290 to the content-distributing part 240. The content-distributing part 240 stores the distribution performance information including the free and non-free classification in the distribution performance storage part 293. The method of storing the distribution performance information including the electronic device ID, the content ID, and the subarea ID in the distribution performance storage part 293 is the same as in the content distribution system 1.

The contribution point-calculating part 250 calculates a contribution point of the content distribution service performed by the content distribution system 3 on the basis of the sales volume information in the sales volume information storage part 291 and the distribution performance information in the distribution performance storage part 293. In other words, the contribution point-calculating part 250 calculates a degree of contribution of the content distribution service of the content distribution system 3 to the specific area A1. The contribution point-calculating part 250 may calculate the contribution point using a calculation formula corresponding to the characteristics of the specific area A1.

For example, the contribution point-calculating part 250 may calculate the contribution point using any one of Calculation Formulas (3) and (4). In Calculation Formulas (3) and (4), P denotes the contribution point, P₁ denotes an admission point (admission fee of a Yen=1 point) into which the admission fee of the sales volume information is converted, and P₂ denotes a distribution point (distribution of one time=b points) into which the number of times of free contents distribution in the distribution performance information is converted. P₃ denotes a purchase point (purchase fee of c Yen=1 point) into which the purchase fee of non-free contents in the distribution performance information is converted and P₄ denotes a distribution point (distribution of one time=d points) into which the number of times of non-free contents distribution in the distribution performance information is converted. Here, a, b, c, and d are predetermined values (coefficients).

P=P₁+P₂+P₃+P₄ (3)

P=(P₂+P₄)/(P₁+P₃) (4)

Calculation Formulas (3) and (4) are only examples and the contribution point-calculating part 250 may calculate the contribution point P using other calculation formulas including the admission point P₁, the distribution point P₂ of free contents, the purchase point P₃, and the distribution point P₄ of non-free contents as variables.

The point storage part 294 stores the contribution point calculated by the contribution point-calculating part 250. That is, the point storage part 294 stores the degree of contribution of the content distribution service performed by the content distribution system 3 to the specific area A1.

### (Application Example 1 of Content Distribution System 3/Zoo)

The specific area A1 is a zoo. A subarea is set for each viewing area of animals. One or both of free contents and non-free contents are stored in the content storage part 290 for each subarea. For example, in the content storage part 290, vibration information (vibration information of vibration generated when an elephant walks) corresponding to movement of an elephant along with moving image information obtained by recording an image in which one elephant walks is stored as free contents in correlation with the subarea of an elephant and vibration information (vibration information of vibration generated when plural elephants cry and run) corresponding to the movement of plural elephants along with moving image information obtained by recording an image in which plural elephants cry and run is stored as non-free contents.

For example, when a distribution request for free contents is received from an electronic device T1 located in a viewing area of elephants (subarea of elephants), the content distribution system 3 distributes free contents (the moving image information obtained by recording an image in which an elephant walks and the vibration information corresponding to movement of an elephant) corresponding to the viewing area of elephants to the electronic device T1. When a distribution request for non-free contents is received from an electronic device T1 located in the viewing area of elephants, the content distribution system 3 distributes non-contents (the moving image information obtained by recording an image in which plural elephants cry and run and the vibration information corresponding to movement of plural elephants) corresponding to the viewing area of lions to the electronic device T1.

That is, a user of an electronic device T1 can obtain free vibration information associated with elephants when requesting free contents in the vicinity of an elephant, and can obtain non-free vibration information associated with elephants when requesting non-free contents in the vicinity of an elephant.

The content distribution system 3 stores the sales volume information (which further includes the purchase fee as for a purchaser of non-free contents) including an admission fee acquired at the time of admission and the distribution performance information of contents (the number of times of distribution of free and non-free classification, the number of times of distribution by animals, the number of times of distribution by electronic devices, and the like) and can calculate the degree of contribution of the content distribution service of the content distribution system 3 to the zoo using the stored sales volume information and distribution performance information.

### (Application Example 2 of Content Distribution System 3/Railway Museum)

The specific area A1 is a railway museum. A subarea is set for each viewing area of each vehicle. The content storage part 290 stores one or both of free contents and non-free contents for each subarea. For example, in the content storage part 290, moving image information and vibration information when the AA system runs in a rural area are stored as free contents in correlation with the subarea of the AA system, and sound information and vibration information when the AA system runs over an iron bridge are stored as non-free contents.

For example, when a distribution request for free contents is received from an electronic device T1 located in the viewing area of the AA system (the subarea of the AA system), the content distribution system 3 distributes to the electronic device T1 free contents (the sound information and the vibration information when the AA system runs in a rural area) corresponding to the viewing area of the AA system. When a distribution request for non-free contents is received from an electronic device T1 located in the viewing area of the AA system, the content distribution system 3 distributes to the electronic device T1 the non-free contents (the sound information and the vibration information when the AA system runs over an iron bridge) corresponding to the viewing area of the AA system.

That is, a user of the electronic device T1 can obtain the free vibration information and the like associated with the AA system when requesting for free contents in the vicinity of the AA system and can obtain the non-free vibration information and the like associated with the AA system when requesting for non-free contents in the vicinity of the AA system.

The content distribution system 3 stores the sales volume information (which further includes the purchase fee as for a purchase of non-free contents) including an admission fee acquired at the time of admission and the distribution performance information of contents (the number of times of distribution of free and non-free classification, the number of times of distribution by vehicles, the number of times of distribution by electronic devices, and the like) and can calculate the degree of contribution of the content distribution service performed by the content distribution system 3 to the railway museum using the stored sales volume information and distribution performance information.

### Fourth Embodiment

A content distribution system 4 according to a fourth embodiment of the present invention is applied to a specific area A2 (such as a baseball park) and provides a content distribution service of distributing contents to mobile electronic devices T2 which are present in the specific area A2, similarly to the content distribution system 2. The content distribution service provided by the content distribution system 4 distributes free contents or non-free contents.

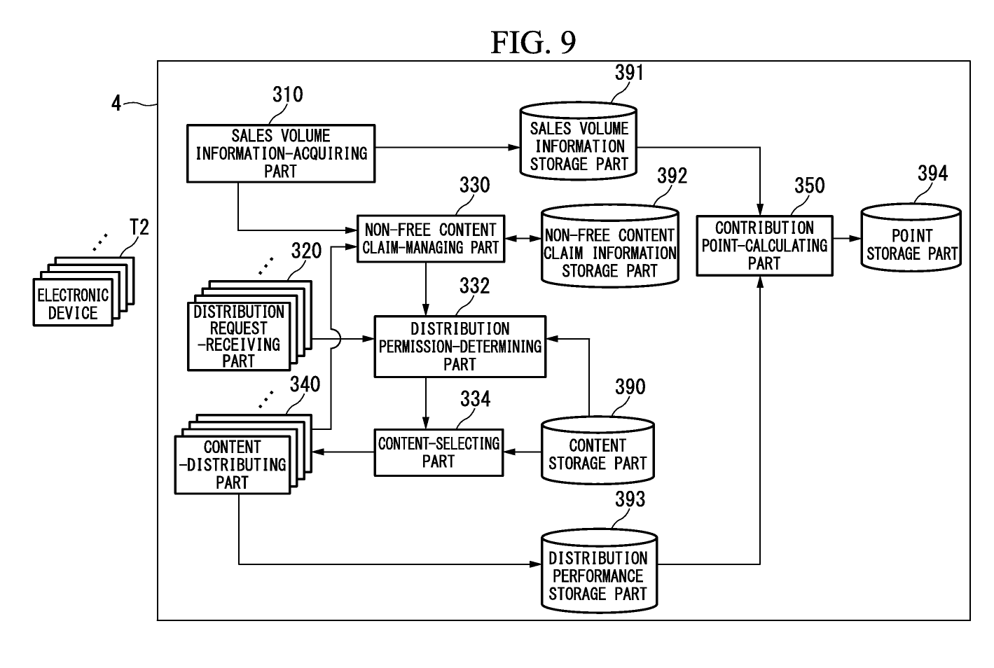

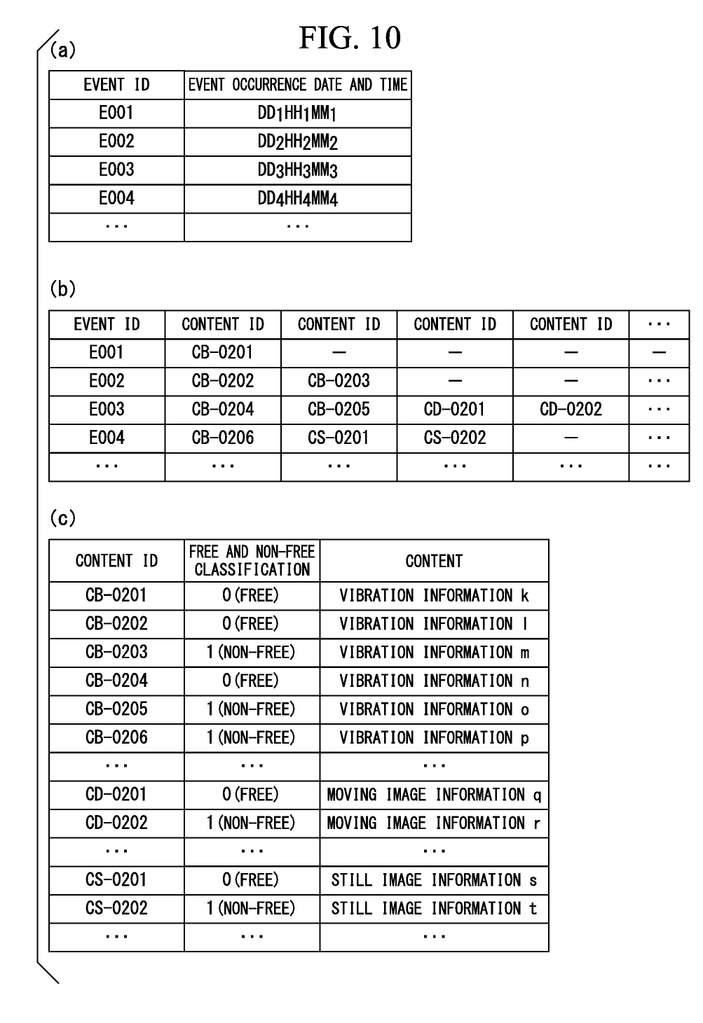

FIG. 9 is a functional block diagram illustrating an example of the content distribution system 4. FIG. 10 is a diagram illustrating an example of information stored in a content storage part 390.

As illustrated in FIG. 9, the content distribution system 4 includes a sales volume information-acquiring part 310, a distribution request-receiving part 320, a non-free content claim-managing part 330, a distribution permission-determining part 332, a content-selecting part 334, a content-distributing part 340, a contribution point-calculating part 350, a content storage part 390, a sales volume information storage part 391, a non-free content claim information storage part 392, a distribution performance storage part 393, and a point storage part 394. The sales volume information-acquiring part 310, the non-free content claim-managing part 330, the sales volume information storage part 391, the non-free content claim information storage part 392, the distribution performance storage part 393, and the point storage part 394 of the content distribution system 4 are the same as the sales volume information-acquiring part 210, the non-free content claim-managing part 230, the sales volume information storage part 291, the non-free content claim information storage part 292, the distribution performance storage part 293, and the point storage part 294 of the content distribution system 3 and thus a part or all of the description thereof will not be repeated.

The content storage part 390 stores contents to be distributed from the content distribution system 4. The contents stored in the content storage part 390 include vibration information (free contents and/or non-free contents) for causing the housing of the electronic device T2 having received the contents to vibrate. The content storage part 390 may store moving image information (free contents and/or non-free contents), still image information (free contents and/or non-free contents), and sound information (free contents and/or non-free contents) as contents in addition to the vibration information.

Specifically, the content storage part 390 stores contents (which includes at least vibration information) corresponding to events in the specific area A2 so as to distinguish free contents and non-free contents from each other. For example, the content storage part 390 stores occurrence date and times of events in correlation with event IDs, as illustrated in FIG. 10(a). In addition, the content storage part 390 stores content IDs in correlation with the event IDs as illustrated in FIG. 10(b). In addition, the content storage part 390 stores the free and non-free classification for distinguishing free contents and non-free contents from each other and the contents, in correlation with the content IDs as illustrated in FIG. 10(c). In the example illustrated in FIG. 10, the content storage part 390 stores vibration information n and moving image information q which are free contents and vibration information o and moving image information r which are non-free contents as contents corresponding to the event with an event ID of “E003” occurring at a date and time of “DD₃HH₃MM₃”.

The method of storing the contents in the content storage part 390 is the same as the method of storing the contents in the content storage part 190 of the content distribution system 2. Old contents (contents after a predetermined time passes from the event occurrence time) may be deleted from the content storage part 390.

The distribution request-receiving part 320 receives a distribution request for contents from the electronic device T2. The distribution request transmitted from the electronic device T2 includes an electronic device ID for identifying the electronic device T2 and information designating non-free contents. In other words, the distribution request-receiving part 320 receives from the electronic device T2 one of the distribution request of a distribution request designating non-free contents and including the electronic device ID, and a distribution request not designating non-free contents as the distribution request including the electronic device ID (or a distribution request designating free contents and including the electronic device ID).

The distribution permission-determining part 332 determines whether the distribution of contents to the electronic device T2 having transmitted the distribution request is permitted. Specifically, the distribution permission-determining part 332 permits the distribution of free contents when the distribution request is transmitted within a predetermined time from the event occurrence time in response to the distribution request not designating non-free contents (or a distribution request designating free contents as the distribution request including the electronic device ID) and including the electronic device ID, and rejects the distribution of free contents when the distribution request is not transmitted within the predetermined time from the event occurrence time. That is, the distribution permission-determining part 332 permits the distribution of free contents when the transmission date and time of the distribution request from the electronic device T2 (or the reception date and time of the distribution request from the distribution request-receiving part 320) is within a predetermined time from the event occurrence date and time of an event stored in the content storage part 390, and rejects the distribution of free contents otherwise.

The distribution permission-determining part 332 permits the distribution of non-free contents when the distribution request is transmitted within a predetermined time from the event occurrence time in response to the distribution request designating non-free contents and including the electronic device ID, and when the non-free content claim information required for the distribution of non-free contents is stored in the non-free content claim-managing part 330 in correlation with the electronic device ID of the mobile electronic device T, and rejects the distribution of non-free contents otherwise. That is, the distribution permission-determining part 332 permits the distribution of non-free contents when the transmission date and time of the distribution request from the electronic device T2 (or the reception date and time of the distribution request by the distribution request-receiving part 320) is within a predetermined time from the event occurrence date and time of an event stored in the content storage part 390 and the purchase fee of the non-free contents is collected, and rejects the distribution of non-free contents when the transmission date and time (the reception date and time) is not within the predetermined time from the event occurrence date and time of an event or the purchase fee of the non-free contents is not collected.

The content-selecting part 334 selects the contents to be distributed to the electronic device T2 to which the distribution is permitted by the distribution permission-determining part 332 from the content storage part 390. For example, the content-selecting part 334 selects from the content storage part 390 the free contents corresponding to the event occurring latest before the transmission time of the distribution request in response to a distribution request not designating non-free contents (or a distribution request designating free contents and including the electronic device ID) as the distribution request including the electronic device ID. For example, when the information illustrated in FIG. 10 is stored in the content storage part 390 and the event occurring latest before the transmission time of the distribution request is the event with an event ID of “E003”, the content-selecting part 334 selects the vibration information n and the moving image information q which are free contents.

The content-selecting part 334 may select from the content storage part 390 free contents (or free contents which are still not transmitted to the electronic device T2 as free contents corresponding to the event occurring within a predetermined time) corresponding to the event occurring within the predetermined time from the transmission date and time of the distribution request from the electronic device T2 (or the reception date and time of the distribution request by the distribution request-receiving part 320).

The content-selecting part 334 selects from the content storage part 390 the non-free contents corresponding to the event occurring latest before the transmission time of the distribution request in response to a distribution request designating non-free contents and including the electronic device ID. For example, when the information illustrated in FIG. 10 is stored in the content storage part 390 and the event occurring latest before the transmission time of the distribution request is the event with an event ID of “E003”, the content-selecting part 334 selects the vibration information o and the moving image information r which are non-free contents.

The content-distributing part 340 distributes the content selected by the content-selecting part 334. The distribution performance storage part 393 stores distribution performance information (which includes free and non-free classification) indicating distribution performance of the content-distributing part 340. The distribution performance information stored in the distribution performance storage part 393 may include one or more of the electronic device ID, the content ID, and the event ID, similarly to the distribution performance information stored in the distribution performance storage part 193.

The content-selecting part 334 outputs the free and non-free classification of the selected content along with the content selected from the content storage part 390 to the content-distributing part 340. The content-distributing part 340 stores the distribution performance information including the free and non-free classification in the distribution performance storage part 393. The method of storing the distribution performance information including the electronic device ID, the content ID, and the event ID in the distribution performance storage part 393 is the same as in the content distribution system 2.

The contribution point-calculating part 350 calculates a contribution point of the content distribution service performed by the content distribution system 4 on the basis of the sales volume information in the sales volume information storage part 391 and the distribution performance information in the distribution performance storage part 393. In other words, the contribution point-calculating part 350 calculates a degree of contribution of the content distribution service of the content distribution system 4 to the specific area A2. The contribution point-calculating part 350 may calculate the contribution point using the same calculation formula as used by the contribution point-calculating part 250 of the content distribution system 3.

As described above, the content distribution system 4 distributes free contents and/or non-free contents corresponding to an event occurring in the specific area A2 to the electronic device T2, but the content distribution system 4 may distribute contents by subareas and events to the electronic device T2 using the same method as in the content distribution system 1 when the subarea areas are set for the specific area A2. When the contents by subareas and events are distributed to the electronic device T2, the contents by subareas and the contents by events are stored in the content storage part 390.

### (Application Example of Content Distribution System 4/Baseball Park)

The specific area A2 is a baseball park. Vibration information and the like associated with an event are stored in the content storage part 390 after the event occurs. For example, after a home run, the content distribution system 4 immediately prepares the vibration information and the like based on the approximate situation (for example, flying distance) of the home run as free contents, immediately prepares the vibration information and the like based on the detailed situation of the home run (for example, features of a batter, a flying distance, a direction of the batted ball, and weather) as non-free contents, and stores the prepared vibration information and the like in the content storage part 390 along with the event ID and the event occurrence time.

For example, when a distribution request for free contents is received from an electronic device T2 immediately after a home run, the content distribution system 4 distributes the vibration information prepared based on the approximate situation of the home run to the electronic device T2. When a distribution request for non-free contents is received from an electronic device T2, the content distribution system 4 distributes the vibration information prepared based on the detailed situation of the home run to the electronic device T2.

That is, a user of an electronic device T2 can obtain free vibration information and the like associated with a home run when requesting free contents immediately after the home run, and can obtain non-free vibration information associated with the home run when requesting non-free contents.

The content distribution system 4 stores the sales volume information (which further includes a purchase fee as for a purchaser of non-free contents) including an admission fee acquired at the time of admission and the distribution performance information of contents (the number of times of distribution of free and non-free classification, the number of times of distribution by events, the number of times of distribution by electronic devices, and the like) and can calculate the degree of contribution of the content distribution service performed by the content distribution system 4 to the baseball park (or the baseball club) using the stored sales volume information and distribution performance information.

As described above, the content distribution systems 1 to 4 distribute the vibration information which can be enjoyed by a sense of touch as well as a sense of sight or a sense of hearing and are thus improved in entertainment value.

The content distribution systems 1 and 3 do not equally provide the same contents to plural electronic devices T1 which are present in the specific area A1, but can distribute different contents depending on the subareas densely set in the specific area A1, and are thus improved in entertainment value.

The content distribution systems 2 and 4 do not equally provide the same contents to plural electronic devices T2 which are present in the specific area A2, but can distribute different contents depending on the events occurring in the specific area A2, and are thus improved in entertainment value.

The content distribution systems 3 and 4 can selectively distribute free contents and non-free contents and are thus improved in entertainment value.

Since the content distribution systems 1 to 4 can calculate the contribution point using the calculation formulas, it is easy to evaluate the system (for example, calculate a degree of contribution of the system introduction to a specific area, such as an improvement in customer attraction and an increase in sales volume) after the content distribution system is introduced.

The content distribution system 1 may further include a privilege-granting part (not illustrated) that grants privileges to authors of contents depending on the distribution performance of the contents (the same is true of the content distribution systems 2 to 4). For example, the content distribution system 1 may distribute contents (for example, vibration of a vehicle which is prepared by a railway buff) prepared by a general user as well as contents prepared by the provider side of the system. The content distribution system 1 can grant a privilege to the general user depending on the distribution performance of the contents which are prepared by himself or herself.

Specifically, information (for example, author ID) on authors of the contents is stored in the content storage part 90 of the content distribution system 1. The content-distributing part 40 stores the distribution performance information including the information on the authors in the distribution performance storage part 93 after distributing the contents. The privilege-granting part (not illustrated) grants privileges (for example, money and goods, a complimentary ticket to entry in a specific area, or special contents which are provided only as a privilege) to the general user depending on the distribution performance with reference to the distribution performance storage part 93.

The aforementioned processes of the content distribution systems 1 to 4 according to the aforementioned embodiments may be performed by recording a program for performing the processes of the content distribution systems 1 to 4 according to the embodiments on a computer-readable recording medium and causing a computer system to read and execute the program recorded on the recording medium. Here, the “computer system” may include an OS or hardware such as peripherals. The “computer system” may include a homepage-providing environment (or display environment) when a WWW system is used. Examples of the “computer-readable recording medium” include writable nonvolatile memories such as a floppy (registered trademark) disk, a magneto-optical disk, an SD card, and a flash memory, portable mediums such as a CD-ROM, and a storage device such as a hard disk built in a computer system.

The “computer-readable recording medium” may include a medium that temporarily holds a program for a predetermined time, like a volatile memory (for example, dynamic random access memory (DRAM)) in a computer system serving as a server or a client in a case where a program is transmitted via a network such as the Internet or a communication circuit such as a telephone circuit. The program may be transmitted from a computer system storing the program in a storage device or the like to another computer system via a transmission medium or by transmission waves in the transmission medium. Here, the “transmission medium” via which the program is transmitted means a medium having a function of transmitting information such as a network (communication network) such as the Internet or a communication circuit (communication line) such as a telephone line. The program may be configured to realize a part of the above-mentioned functions or may be configured to realize the above-mentioned functions by combination with a program recorded in advance in a computer system, like a so-called differential file (differential program).

While the embodiments of the present invention have been described above in detail with reference to the accompanying drawings, the specific configuration thereof is not limited to the aforementioned embodiments and includes designs and the like without departing from the gist of the present invention.

What is claimed is:

1. A content distribution system that provides a content distribution service of distributing content to mobile electronic device present in a specific area, the content distribution system comprising:
a content storage part configured to store at least information, which corresponds to a subarea set in advance inside the specific area, as the content;
a sales volume information-acquiring part configured to acquire sales volume information including an admission fee to the specific area;
a sales volume information storage part configured to store the sales volume information;
a distribution request-receiving part configured to receive a distribution request for a content from the mobile electronic device;
a distribution permission-determining part configured to determine whether a distribution of a content to the mobile electronic device having transmitted the distribution request is permitted;
a content-selecting part configured to select the content to be distributed to the mobile electronic device, to which the distribution of the content is permitted by the distribution permission-determining part, from the content storage part;
a content-distributing part configured to distribute the content selected by the content-selecting part;
a distribution performance storage part configured to store distribution performance information indicating distribution performance by the content-distributing part; and
a contribution point-calculating part configured to calculate a contribution point of the content distribution service on the basis of the sales volume information in the sales volume information storage part and the distribution performance information in the distribution performance storage part.

2. The content distribution system according to claim 1,
wherein the content include vibration information corresponding to the subareas.

3. The content distribution system according to claim 1,
wherein the distribution permission-determining part permits a distribution of a content when the distribution request is transmitted from one of the subareas, and rejects a distribution of a content when the distribution request is transmitted from an outside of the subareas, and
wherein the content-selecting part selects the content corresponding to the subarea to which a transmission position of the distribution request belongs.

4. The content distribution system according to claim 1,
wherein the content distribution service is a service of distributing a free content which is a content for free and/or a non-free content which is a paid content,
wherein the content distribution system further comprises:
a non-free content claim information storage part configured to store non-free content claim information indicating a claim for the non-free content in correlation with device identification information for identifying the mobile electronic device; and
a non-free content claim-managing part configured to manage the non-free content claim information,
wherein the content storage part stores the free content and the non-free content so as to be distinguished from each other,
wherein the sales volume information-acquiring part acquires sales volume information including purchase fees of the non-free content,
wherein the non-free content claim-managing part accumulates the non-free content claim corresponding to the device identification information of the mobile electronic device of a purchaser according to an acquisition of sales volume information of the non-free contents, and consumes the non-free content claim corresponding to the device identification information of the mobile electronic device according to a distribution of the non-free contents to the mobile electronic device,
wherein the distribution request-receiving part receives the distribution request designating the non-free content or the distribution request not designating the non-free content,
wherein the distribution permission-determining part permits a distribution of the non-free content when the distribution request designating the non-free content is transmitted from one of the subareas and when the non-free content claim information required for distributing the non-free content is stored in the non-free content claim information storage part in correlation with device identification information for identifying the mobile electronic device having transmitted the distribution request, and
wherein the content-selecting part selects the non-free content corresponding to the subarea to which a transmission position of the distribution request designating the non-free content belongs.

5. The content distribution system according to claim 2,
wherein the specific area is a zoo, and
wherein the vibration information is vibration information associated with animals.

6. The content distribution system according to claim 2,
wherein the specific area is a railway museum, and
wherein the vibration information is vibration information associated with railways.

7. A content distribution system that provides a content distribution service of distributing content to mobile electronic device present in a specific area, the content distribution system comprising:
a content storage part configured to store at least information, which corresponds to event occurring inside the specific area, as the content;
a sales volume information-acquiring part configured to acquire sales volume information including an admission fee to the specific area;
a sales volume information storage part configured to store the sales volume information;
a distribution request-receiving part configured to receive a distribution request for a content from the mobile electronic device;
a distribution permission-determining part configured to determine whether a distribution of a content to the mobile electronic device having transmitted the distribution request is permitted;
a content-selecting part configured to select the content to be distributed to the mobile electronic device, to which the distribution of the content is permitted by the distribution permission-determining part, from the content storage part;
a content-distributing part configured to distribute the content selected by the content-selecting part;
a distribution performance storage part configured to store distribution performance information indicating distribution performance by the content-distributing part; and
a contribution point-calculating part configured to calculate a contribution point of the content distribution service on the basis of the sales volume information in the sales volume information storage part and the distribution performance information in the distribution performance storage part.

8. The content distribution system according to claim 7,
wherein the content include vibration information corresponding to the event.

9. The content distribution system according to claim 7,
wherein the distribution permission-determining part permits a distribution of a content when the distribution request is transmitted within a predetermined time from an occurrence time of the event, and rejects a distribution of a content when the distribution request is not transmitted within a predetermined time from an occurrence time of the event, and
wherein the content-selecting part selects the content corresponding to the event occurring latest before a transmission time of the distribution request.

10. The content distribution system according to claim 7,
wherein the content distribution service is a service of distributing a free content which is a content for free and/or a non-free content which is a paid content,
wherein the content distribution system further comprises:
a non-free content claim information storage part configured to store non-free content claim information indicating a claim for the non-free content in correlation with device identification information for identifying the mobile electronic device; and
a non-free content claim-managing part configured to manage the non-free content claim information,
wherein the content storage part stores the free content and the non-free content so as to be distinguished from each other,
wherein the sales volume information-acquiring part acquires sales volume information including purchase fees of the non-free content,
wherein the non-free content claim-managing part accumulates the non-free content claim corresponding to the device identification information of the mobile electronic device of a purchaser according to an acquisition of sales volume information of the non-free content, and consumes the non-free content claim corresponding to the device identification information of the mobile electronic device according to a distribution of the non-free content to the mobile electronic device,
wherein the distribution request-receiving part receives the distribution request designating the non-free content or the distribution request not designating the non-free content,
wherein the distribution permission-determining part permits a distribution of the non-free content when the distribution request designating the non-free content is transmitted within a predetermined time from an occurrence time of the event and when the non-free content claim information required for distributing the non-free content is stored in the non-free content claim information storage part in correlation with device identification information for identifying the mobile electronic device having transmitted the distribution request, and
wherein the content-selecting part selects the non-free content corresponding to the event occurring latest before a transmission time of the distribution request designating the non-free content.

11. The content distribution system according to claim 1,
wherein the contribution point-calculating part calculates the contribution point using a calculation formula based on a characteristic of the specific area.

12. The content distribution system according to claim 1, further comprising a privilege-granting part configured to grant privilege to author of each contents depending on a distribution performance of the content.
